(19) United States
(12) Patent Application Publication
(10) Pub. No.: US 2024/0320350 A1
(43) Pub. Date: Sep. 26, 2024

(54) Video and Image Recording For an Air Gapped System

(71) Applicants: Curtis SOMOZA, Lake Forest, CA (US); Don NAVA, Lake Forest, CA (US)

(72) Inventors: Curtis SOMOZA, Lake Forest, CA (US); Don NAVA, Lake Forest, CA (US)

(21) Appl. No.: 18/126,475

(22) Filed: Mar. 26, 2023

(51) Int. Cl. G06F 21/60; G06F 21/62; G06Q 20/38; G06Q 20/40; G06V 30/10

(52) U.S. Cl. CPC G06F 21/606; G06F 21/602; G06F 21/62; G06Q 20/382; G06Q 20/389; G06Q 20/403; G06V 30/10; G06Q 2220/00

(57) ABSTRACT

The embodiments disclose an image capturing system including at least one transactions ledger public screen coupled to a transaction marketplace platform configured to display a current status of user transactions, an air-gapped system platform configured to securely control adjustments to the transactions ledger, a camera coupled to the air-gapped system platform configured to capture images of the at least one transactions ledger public screen display of a current status of user transactions, an optical character recognition device coupled to the camera configured to convert the captured image into text, a computer coupled to the air-gapped system platform configured to adjust the transaction status, a quantum state encryption device coupled to the computer configured to encrypt the completed transaction status adjustments, and a portable memory device coupled to the computer configured to record and to transfer the transactions status adjustments to the transaction marketplace platform distributed database.

### BACKGROUND

The growth in hacking of private and sensitive data has emphasized the need for greater levels of security for computerized data. The internet has facilitated access to data. What is needed is a system of increased security that bypasses the internet to avoid the possibility of hacking.

### BRIEF DESCRIPTION OF THE DRAWINGS

FIG. 1 shows for illustrative purposes only an example of an overview of an air-gapped system platform of one embodiment.

FIG. 2 shows for illustrative purposes only an example of an overview of the digital transaction ledger of one embodiment.

FIG. 3 shows a block diagram of an overview flow chart of creating a transaction marketplace platform of one embodiment.

FIG. 4 shows a block diagram of an overview flow chart of the transaction ledger adjustments using an air-gapped system of one embodiment.

FIG. 5 shows for illustrative purposes only an example of an overview of the NFT global reserve of one embodiment.

FIG. 6 shows a block diagram of an overview of the global reserve platform of one embodiment.

FIG. 7 shows a block diagram of an overview of accumulating appreciating NFT assets of one embodiment.

FIG. 8 shows a block diagram of an overview of the global dollars cryptocurrency of one embodiment.

FIG. 9 shows a block diagram of an overview of quantum state encryption of one embodiment.

FIG. 10 shows a block diagram of an overview of the transactions ledger of one embodiment.

FIG. 11 shows a block diagram of an overview of global reward dollars of one embodiment.

FIG. 12 shows a block diagram of an overview of a smart contract of one embodiment.

FIG. 13 shows a block diagram of an overview of global reserve real estate transfer dollars of one embodiment.

FIG. 14 shows a block diagram of an overview of global connections digital assets of one embodiment.

FIG. 15 shows a block diagram of an overview of GCDA as a token of one embodiment.

FIG. 16 shows a block diagram of an overview of GCDA smart contracts of one embodiment.

FIG. 17 shows a block diagram of an overview of the NFT creation process of one embodiment.

FIG. 18 shows a block diagram of an overview of the legal agreement for the asset of one embodiment.

FIG. 19 shows a block diagram of an overview of the NFT asset value of one embodiment.

FIG. 20 shows a block diagram of an overview of an authorized party(s) to control the NFT of one embodiment.

FIG. 21 shows a block diagram of an overview of liens against the NFT and its accounts of one embodiment.

FIG. 22 shows a block diagram of an overview of the NFT transfers of one embodiment.

FIG. 23 shows a block diagram of an overview of the GCDA NFT of one embodiment.

FIG. 24 shows a block diagram of an overview of the Quantum State Encryption (QSE) of one embodiment.

FIG. 25 shows a block diagram of an overview of the Quantum State Encryption (QSE) (continued) of one embodiment.

FIG. 26 shows a block diagram of an overview of the Quantum State Encryption (QSE) (2^{ND} continuation) of one embodiment.

### DETAILED DESCRIPTION OF THE INVENTION

In the following description, reference is made to the accompanying drawings, which form a part hereof, and which are shown by way of illustration a specific example in which the invention may be practiced. It is to be understood that other embodiments may be utilized and structural changes may be made without departing from the scope of the present invention.

### General Overview

It should be noted that the descriptions that follow, for example, in terms of video and image recording for an air gapped system are described for illustrative purposes and the underlying system can apply to any number and multiple types of user transactions. In one embodiment of the present invention, the video and image recording for an air gapped system can be configured using an OCR device. The video and image recording for an air gapped system can be configured to include a camera and can be configured to include a quantum state encryption device using the present invention.

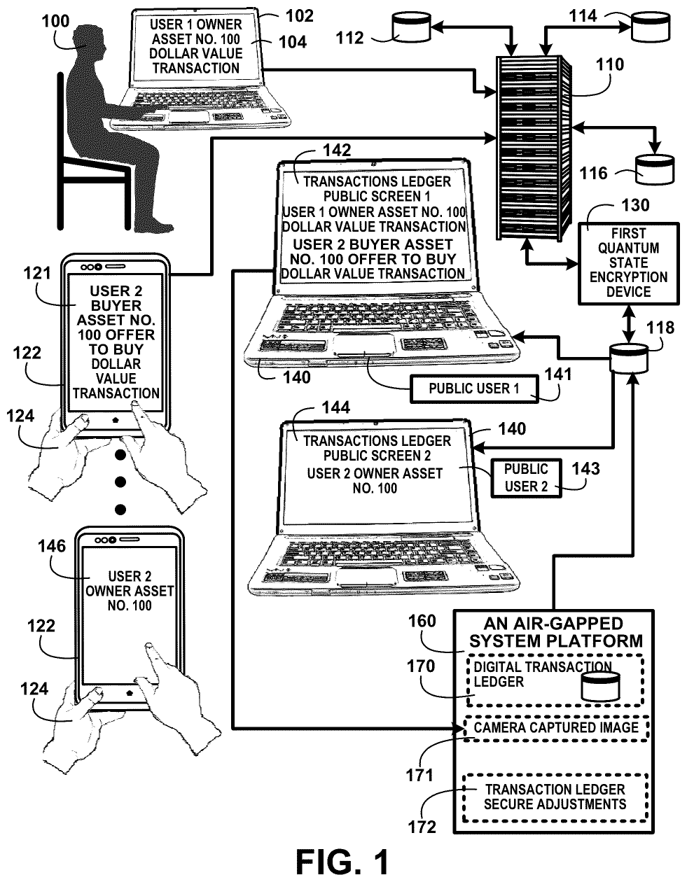

FIG. 1 shows for illustrative purposes only an example of an overview of an air-gapped system platform of one embodiment. FIG. 1 shows user 1 100 at the user 1 laptop computer with a quantum state encryption device 102. User 1 is registering user 1 owner asset no. 100 dollar value transaction 104 on the transaction marketplace platform 110. The transaction marketplace platform 110 is connected to a distributed database shown in this example as distributed database 1 112, distributed database 2 114, distributed database 3 116, and distributed database 4 118. Distributed databases are used to store and retrieve user data.

User 2 124 registers a user 2 buyer asset no. 100 offer to buy dollar value transaction 121 registers using a user 2 smartphone with a quantum state encryption device 122. A first quantum state encryption device 130 encrypts both the user 1 100 and the user 2 data being registered. Any digital computer 140 may display the current status of transactions registered on the transaction marketplace platform 110. In an example, a transactions ledger public screen 1 is displaying the user 1 owner asset no. 100 dollar value transaction and user 2 buyer asset no. 100 offer to buy dollar value transaction 142 for a public user 1 141 to view.

Transaction data is not available to the public or registered users to adjust any transaction data. Transaction data is recorded in the digital transaction ledger 170 secured in an air-gapped system platform 160. The air-gapped system platform 160 is limited to authorized access only. To further prevent hacking into the digital transaction ledger 170 a camera captured image 171 of the transactions ledger public screen 1 display is processed to make transaction ledger secure adjustments 172. The camera-captured image 171 eliminates an internet connection or wired connection to the distributed database thus not allowing hackers to be able to make any adjustments to the digital transaction ledger 170.

The air-gapped system platform 160 then transfers the transaction ledger secure adjustments 172 using, for example, a portable memory device coupled to the air-gapped system platform computer configured to record the encrypted adjustments to the transaction status and further configured to non-wirelessly transfer the encrypted transaction ledger secure adjustments 172 into the distributed database via in this example distributed database 4 118. Any digital computer 140 can display the post-adjusted transaction status for example as shown in transactions ledger public screen 2 144 showing the user 2 owner asset no. 100 146 for viewing by public user 2 143 of one embodiment.

### DETAILED DESCRIPTION

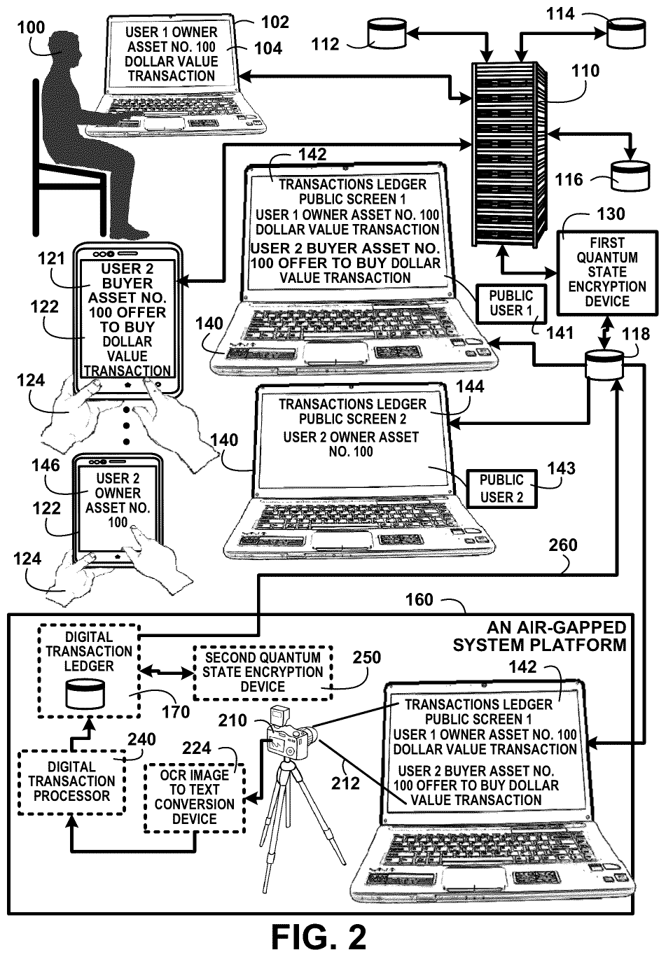

FIG. 2 shows for illustrative purposes only an example of an overview of a digital transaction ledger of one embodiment. FIG. 2 shows user 1 100 working at a user 1 laptop computer with a quantum state encryption device 102. User 1 100 is registering a user 1 owner asset no. 100 dollar value transaction 104. This transaction is loaded into the transaction marketplace platform 110. A user can access the transaction marketplace platform with a mobile app or through a web portal. The user can view asset images through a typical screen or with other viewing instruments. Other viewing instruments include those that superimpose virtual and real-world assets into a user's real-world setting.

The transaction marketplace platform contains images, videos, and other schematics of properties that users can view and interact with asset images, videos, and other schematics of properties.

A user enters the transaction marketplace platform and searches for an asset they want to acquire. If the user finds an asset (property) that they want to acquire they proceed to the acquisition section. The acquisition section collects the user's information and confirms the user has adequate funds to complete the transaction. A customizable asset control feature coupled to the transaction marketplace platform configured to set user selected transaction details and use of the asset including at least setting an asset monthly lease fee, a sublet smart contract, an exchange of assets, or transfer a smart contract to another asset.

The transaction marketplace platform 110 records the transaction in one of many databases for example distributed database 1 112, distributed database 2 114, distributed database 3 116, and distributed database 4 118. These databases in this example make up distributed databases to store users' transactions. In another instance, user 2 124 uses a user 2 smartphone with a quantum state encryption device 122 to register on the transaction marketplace platform 110 another transaction user 2 buyer asset no. 100 offer to buy dollar value transaction 121. User 2 124 is responding to what was displayed on transactions ledger public screen 1 142 user 1 owner asset no. 100 dollar value transaction 104 that was updated to show the user 2 buyer asset no. 100 offer to buy dollar value transaction 121. The updated transactions displayed are available for viewing on any digital computer 140 by a public user 1 141.

The transaction marketplace platform 110 encrypts the transactions using the first quantum state encryption device 130. An air-gapped system platform 160 houses the digital transaction ledger 170 in a secure area only accessible by authorized personnel. A camera 210 is used to obtain a camera-captured image 212 of the transactions ledger public screen 1 142 displayed transactions current status. An optical character recognition (OCR) is coupled to a digital transaction processor 240. The camera-captured image 212 is processed using an OCR image-to-text conversion device 224 to update the status of the transactions. After processing the completion of the transactions a second quantum state encryption device 250 is used to encrypt the updated transaction status. The camera-captured image 171 eliminates an internet connection or wired connection to the distributed database thus not allowing hackers to be able to make any adjustments to the digital transaction ledger 170. In this manner, the transaction ledger secure adjustments 172 remain secured before transferring to in this example distributed database 4 118. The encryption after processing is followed by the encrypted completed transaction physical transfer 260 of the updated transaction status to the distributed database. The updated transaction information can be displayed for example on any digital computer 140 as shown in transactions ledger public screen 2 144 for viewing by for example a public user 2 143 showing user 2 owner asset no. 100 146 is the current status as the sale and purchase have been completed of one embodiment.

### A Transaction Marketplace Platform:

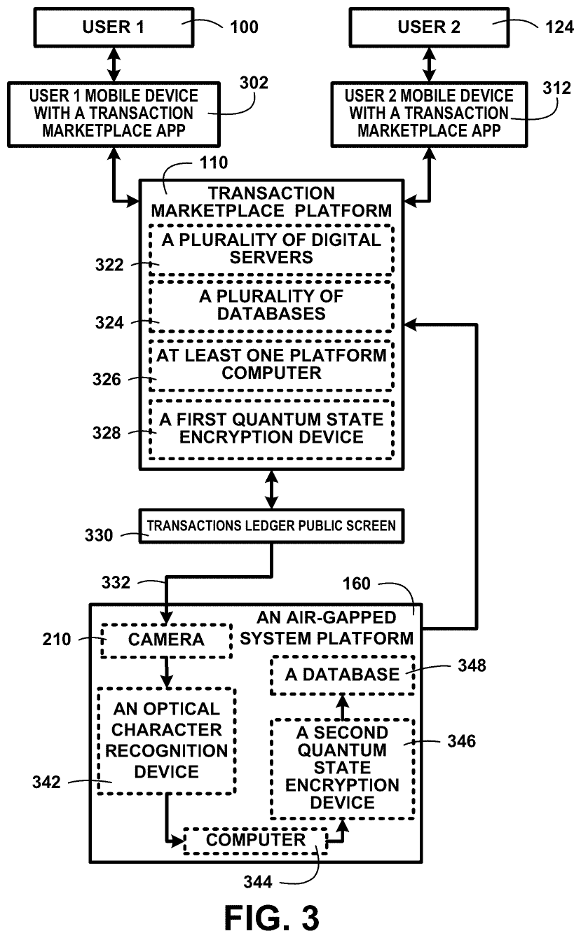

FIG. 3 shows a block diagram of an overview of a transaction marketplace platform of one embodiment. FIG. 3 shows user 1 100 using a user 1 mobile device with a transaction marketplace app 302 to register a transaction on the transaction marketplace platform 110. User 2 124 using a user 2 mobile device with a transaction marketplace app 312 to register a transaction on the transaction marketplace platform 110 is also shown. The transaction marketplace platform 110 comprises at least a plurality of digital servers 322, a plurality of databases 324, at least one platform computer 326, and a first quantum state encryption device 328. At least one transactions ledger public screen 330 may display the registered transactions' current status. An air-gapped system platform 160 in a secure location uses a camera 210 to capture a screen image 332 of the transactions ledger public screen 330 transactions current status. An optical character recognition device 342 converts the captured screen image into readable digital text. An air-gapped system platform 160 computer 344 processes the transactions to a completed status. A second quantum state encryption device 346 encrypts the completed transaction before the completed transaction is physically uploaded into a database 348 of the transaction marketplace platform 110 distributed database of one embodiment.

### Transaction Ledger Adjustments Using an Air-Gapped System:

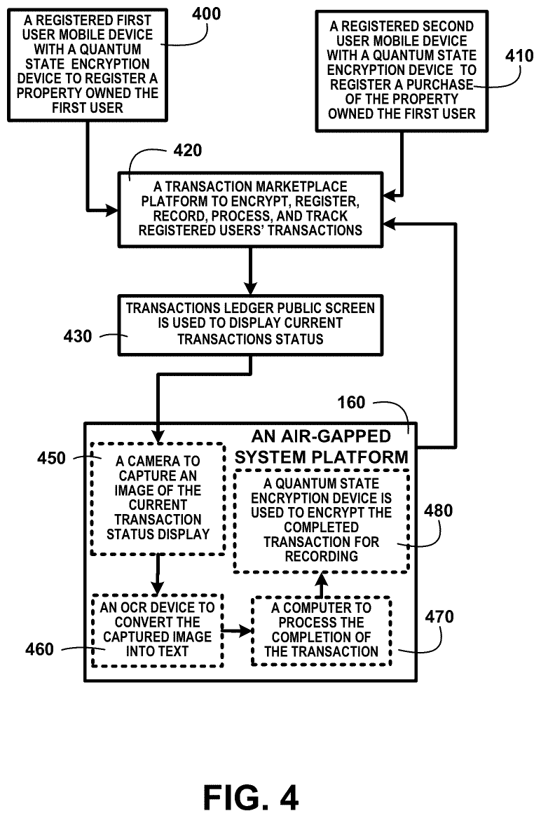

FIG. 4 shows a block diagram of an overview flow chart of the transaction ledger adjustments using an air-gapped system of one embodiment. FIG. 4 shows a registered first user mobile device to register a property owned by the first user 400. A registered second user mobile device to register a purchase of the property owned by the first user 410. The two transaction registrations are transmitted to a transaction marketplace platform to encrypt, register, record, process, and track registered users' transactions 420. A transactions ledger public screen is used to display current transactions status 430. An air-gapped system platform 160 is used to make secure adjustments to user transactions. A camera is used to capture an image of the current transaction status display 450. This eliminates internet or wired connections that may allow hackers to access the transactions. An OCR device is used to convert the captured image into text 460. A computer is used to process the completion of the transaction 470. A quantum state encryption device is used to encrypt the completed transaction for recording 480 in the distributed database by a physical transfer means of one embodiment.

### NFT Global Reserve:

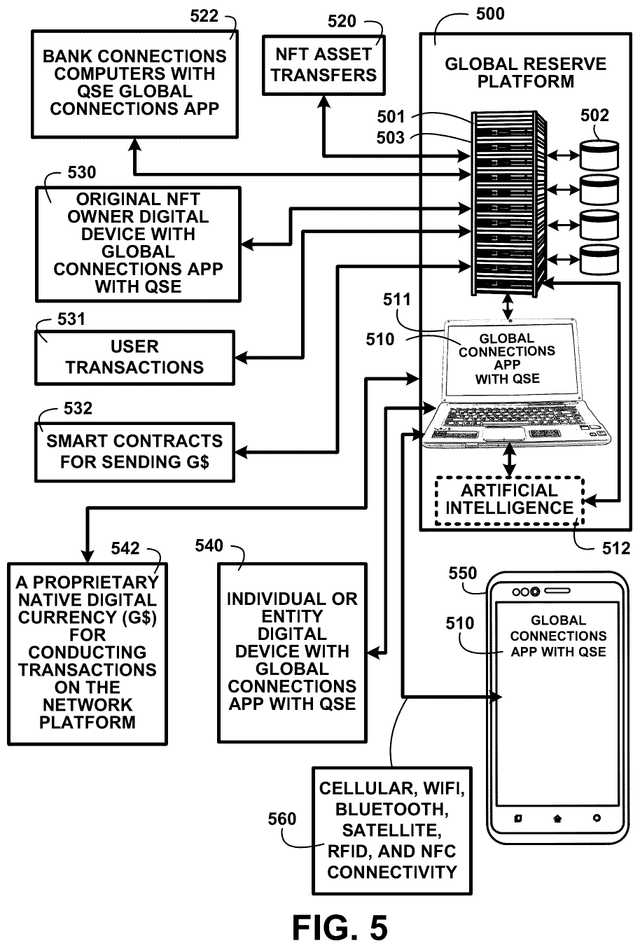

FIG. 5 shows for illustrative purposes only an example of an overview of the NFT global reserve of one embodiment. FIG. 5 shows a global reserve platform 500. The GR platform 500 comprises a plurality of digital servers 501, a plurality of databases 502, a plurality of data processors 503, a platform computer 511, a quantum state encryption (QSE) system, a global connections app with QSE 510, an artificial intelligence device 512, cellular, WIFI, Bluetooth, satellite, radio-frequency identification (RFID), and near-field communication (NFC) connectivity 560. A user digital device includes a smartphone 550 with a global connections app with QSE 510. The cellular, WIFI, Bluetooth, satellite, RFID, and NFC connectivity 560 allows numerous connections for an individual or entity digital device with global connections app with QSE 540.

The global reserve platform 500 provides a proprietary native digital currency (G$) for conducting transactions on the network platform 542. Transactions can be made between an original non-fungible token (NFT) owner digital device with global connections app with QSE 530, for user transactions 531 with smart contracts for sending G$ 532, NFT asset transfers 520, and bank connections computers with a QSE global connections app 522 of one embodiment.

### Global Reserve Platform:

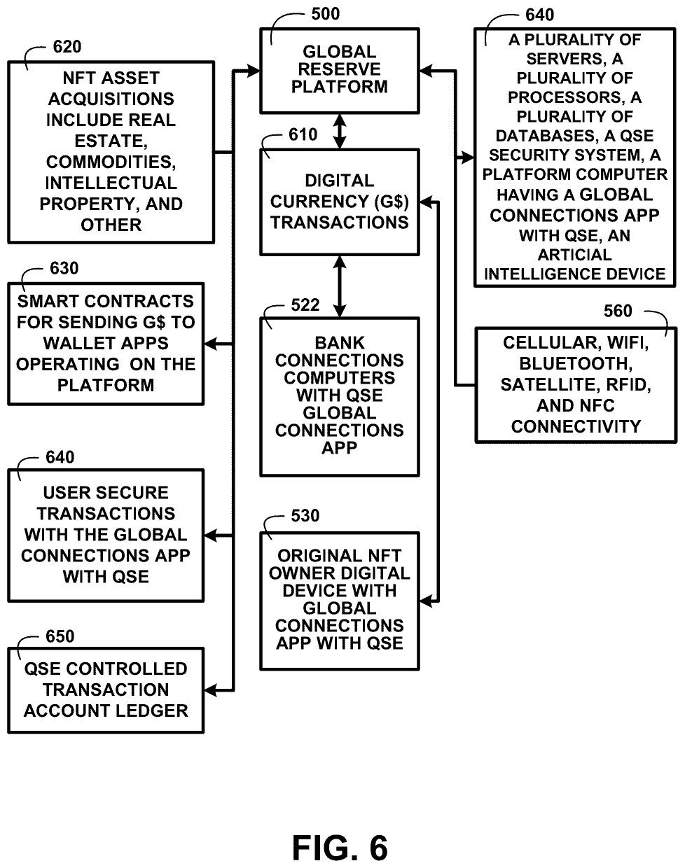

FIG. 6 shows a block diagram of an overview of the global reserve platform of one embodiment. FIG. 6 shows the global reserve platform 500 with a plurality of servers, a plurality of processors, a plurality of databases, a QSE security system, a platform computer having a global connections app with QSE, an artificial intelligence device 600 for conducting digital currency (G$) transactions 610. Transactions can be made via cellular, WIFI, Bluetooth, satellite, RFID, and NFC connectivity 560. Transactions can be made between bank connections computers with the QSE global connections app 522 and for example an original NFT owner digital device with the global connections app with QSE 530. NFT asset acquisitions include real estate, commodities, intellectual property, and other 620 smart contracts for sending G$ to wallet apps operating on the platform 630. User-secure transactions with the global connections app with QSE 640 are recorded on a QSE-controlled transaction account ledger 650 of one embodiment.

### Accumulating Appreciating NFT Assets:

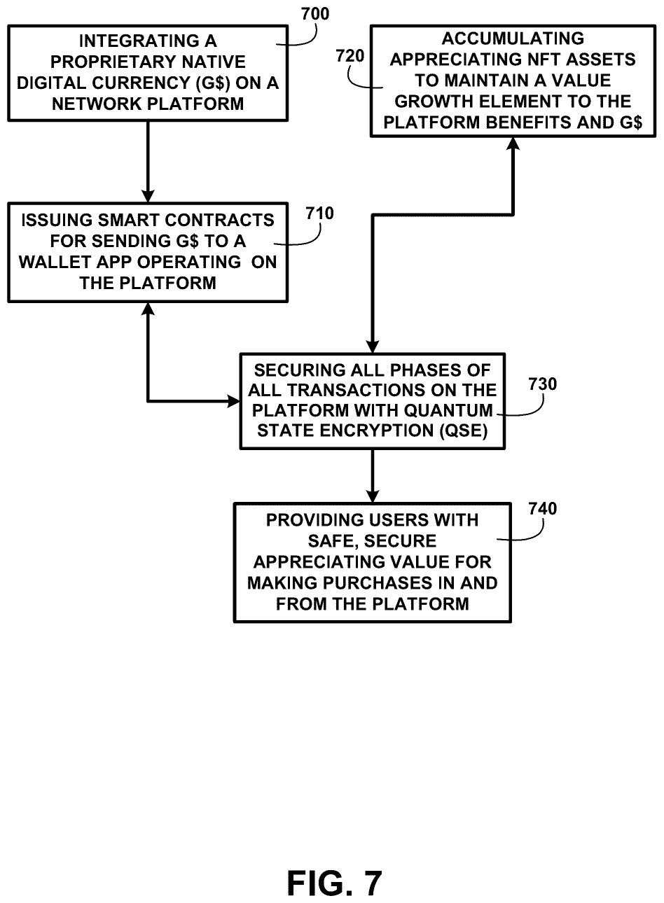

FIG. 7 shows a block diagram of an overview of accumulating appreciating NFT assets of one embodiment. FIG. 7 shows integrating a proprietary native digital currency (G$) on a network platform 700 for issuing smart contracts for sending G$ to a wallet app operating on the platform 710. The proprietary native digital currency (G$) is backed by accumulating appreciating NFT assets to maintain a value growth element to the platform benefits and G$ 720. All platform transactions are protected by securing all phases of all transactions on the platform with quantum state encryption (QSE) 730. The added security systems are providing users with safe, secure appreciating value for making purchases in and from the platform 740 of one embodiment.

The NFT Real Estate Acquisition Program (REAP) allows users the ability to acquire real estate. The process involves the creation of an NFT (Non-Fungible Token) that represents the right to use and acquire a particular piece of real estate. Essentially a lease with an option to purchase contract. The uniqueness is the way the payments are structured and the way the equity and full ownership rights are transferred.

The NFT is created utilizing blockchain technology. It can be on any of the current blockchains that support Non-Fungible Tokens, or any new centralized or decentralized blockchain technology. The NFT records the description of the particular piece of real estate plus the details of the transfer of ownership. The owner of the NFT is recorded in the blockchain and the current owner of the NFT has the right to complete the transfer of the real estate if they complete the needed and described steps.

At the creation of the NFT, the underlying real estate title is transferred to a Trust Company that holds title until the conditions in the NFT are met. An underwriter will be responsible for overseeing aspects of the NFT to ensure compliance with all terms.

An additional unique aspect of this program is the creation of Fungible Tokens called Global Dollars (G$), which represent the value of the equity of real estate that is in the process of being transferred. It is preferred that these tokens are on the same blockchain as the NFTs but it is not a requirement of this claim.

The value of the Global Dollars is a fixed escalating value in relation to the national fiat currency where the real estate is located. The escalation of the value is to mimic the average appreciation of the value of the real estate for which the token is being used to transfer the value. The escalation in value can occur once per day, once per hour, once per minute, or at any set interval.

The Global Dollars are not tied directly to any one piece of real estate but are fungible to be a representative of any piece of real estate in the program being transferred. Each Global Dollar is also divisible so fractions of them can be acquired at the corresponding price at any time. Global Dollars are available to be bought and sold by any party, not just buyers and/or sellers of real estate.

When creating the NFT, the value of the real estate is determined between the seller and buyer, and the corresponding amount of Global Dollars is noted in the NFT agreement. If the buyer purchases all of the needed Global Dollars at the time the NFT is created, then the cost would equal the value agreed upon at creation. If the buyer acquires the needed amount of Global Dollars after the creation of the NFT, then the cost would be relatively higher depending on the amount and time those additional Global Dollars were acquired.

To complete the purchase and full transfer of ownership, the current owner of the NFT presents the NFT and the required amount of Global Dollars to the Trust Company. At this time the ownership rights and title are conveyed as agreed.

The Global Dollars and NFT can be sold at any time to any party willing to purchase them. The NFT is non-fungible and divisible. The REAP is essentially a leasehold interest with an option to buy that is recorded and carried out with blockchain technology.

### Depreciating Asset and Other Purchases:

For purchases other than for appreciating assets, Global Connections offers a unique discount program that utilizes the steady appreciation of the G$. The Basic Acquisition Program (BAP) structures payments over the useful life of what is being purchased. With the appreciating nature of G$, their increased purchasing power lowers the amount needed to cover the payments that are spread out over several years. The longer the payments are being spread out over, the greater the discount achieved by the purchasing power of the G$.

The BAP has three parties. The buyer, the seller, and the underwriter. The underwriter is responsible for making sure all of the payments are guaranteed to be paid for. G$ transactions have no default risk because all funds needed to make all payments must be blocked in an account to initiate the transaction.

The underwriter determines the amount of a discount given to the buyer and/or bonus to the seller. This is computed by estimating the future appreciation of the G$ compared to the number of payments needed to be made over the term. From this, the underwriter can calculate how much they need to collect from the buyer and how much they can pay the seller. Either the buyer or seller can also act as the underwriter.

The concept is that the purchasing power of the G$ will lessen the overall cost of a purchase when the payments are structured over time. The longer the time, the greater the effect of the increase in G$ purchasing power and the greater the discount, or bonus, the buyer or seller will receive.

When a new transaction is added, G$'s are created and delivered to the seller, the buyer has to arrange to guarantee that the payments over the term are covered. The buyer or underwriter has to make agreed-upon payments and as those payments are made, the G$ used is consumed.

The value of what is being paid overtime is greater than the cost of the purchase. This increase covers the cost of the use of funds. The underwriter takes the risk that the purchasing power of the G$ is greater than the additional cost to structure the payments over a term. If the purchasing power is greater, then the underwriter keeps all of the overages. With the predicted purchasing power to be far greater than the value used for the cost of funds, the underwriters look to make substantial profits while still providing a considerable discount to buyers.

### Global Dollars Cryptocurrency:

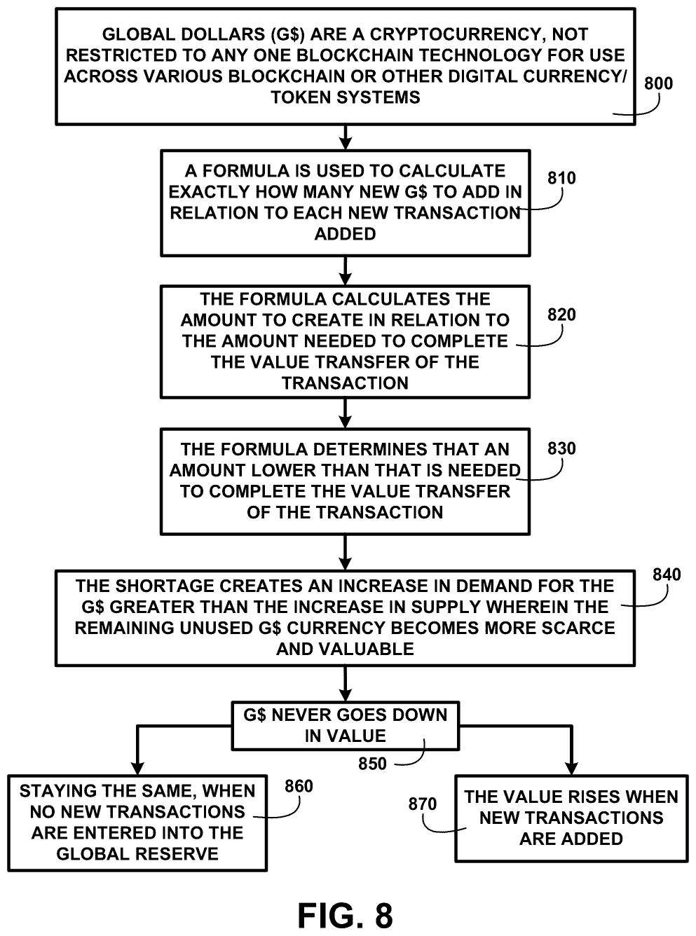

FIG. 8 shows a block diagram of an overview of the global dollars cryptocurrency of one embodiment. FIG. 8 shows the proprietary native digital currency referred to as global dollars (G$) are a cryptocurrency, not restricted to any one blockchain technology for use across various blockchain or other digital currency/token systems 800. A formula is used to calculate exactly how many new G$ to add in relation to each new transaction added 810. The new transactions added are appreciating and depreciating NFT assets. The formula calculates the amount to create in relation to the amount needed to complete the value transfer of the transaction 820. The formula determines that an amount lower than that is needed to complete the value transfer of the transaction 830. The shortage creates an increase in demand for the G$ greater than the increase in supply wherein the remaining unused G$ currency becomes more scarce and valuable 840. These calculated shortages assure G$ never goes down in value 850. The G$ value is staying the same when no new transactions are entered into the global reserve 860 and the value rises when new transactions are added 870.

Global Dollars (G$) are digital commodities, a needed piece for Global Connections Digital Assets (GCDA). Each GCDA has two types of components, the NFT with smart contract controls and a certain amount of Global Dollars. G$ is a true commodity as it is the Digital raw material needed to bring value to other things. The basis is a pool of assets that can only be used when supplied by the requisite amount of Global Dollars. To have the legal right to use or purchase an underlying asset, one must present the needed Global Dollars to complete the digital contract.

Global Dollars are created when assets are placed into a pool and the use of those assets is directly tied to supplying the needed amount of Global Dollars. When a real-world asset is placed in the Global Connections platform, to complete the digitization of this asset, a chosen amount of Global Dollars is needed to allow for the use and/or purchase of this asset. Global Dollars represent the digital raw material needed to complete the product and have it have value for the user. The resulting product is a Digital Use Rights Contract of an underlying asset of one embodiment.

### Quantum State Encryption:

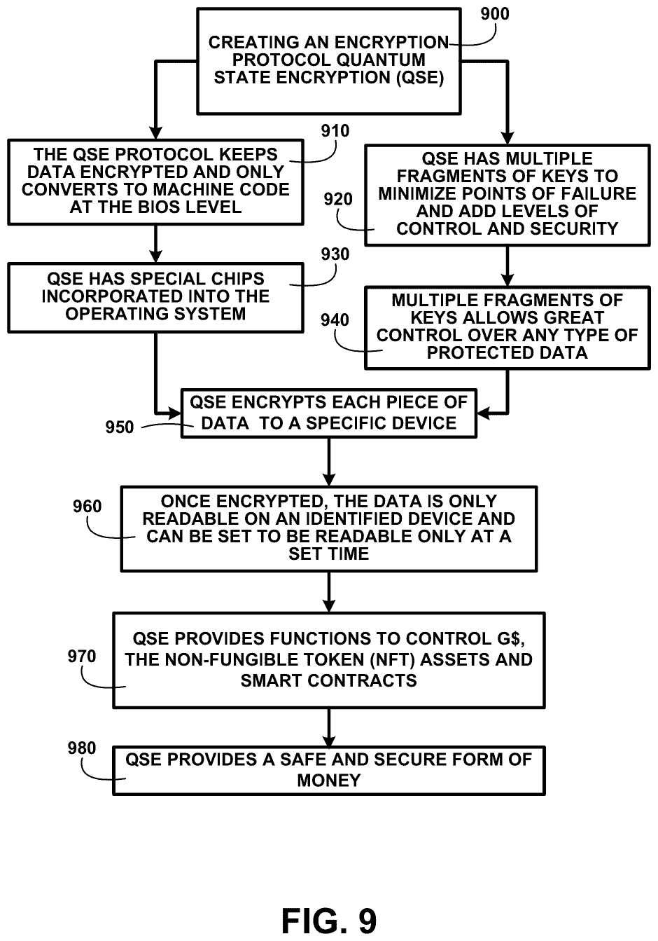

FIG. 9 shows a block diagram of an overview of quantum state encryption of one embodiment. FIG. 9 shows creating an encryption protocol quantum state encryption (QSE) 900. The QSE protocol keeps data encrypted and only converts to machine code at the bios level 910. QSE has special chips incorporated into the operating system 920. The special chips for QSE have multiple fragments of keys to minimize points of failure and add levels of control and security 930. Multiple fragments of keys allow great control over any type of protected data 940. QSE encrypts each piece of data to a specific device 950. Once encrypted, the data is only readable on an identified device and can be set to be readable only at a set time 960. QSE provides functions to control G$, the non-fungible token (NFT) assets, and smart contracts 970. QSE provides a safe and secure form of money 980 of one embodiment.

### Transactions Ledger:

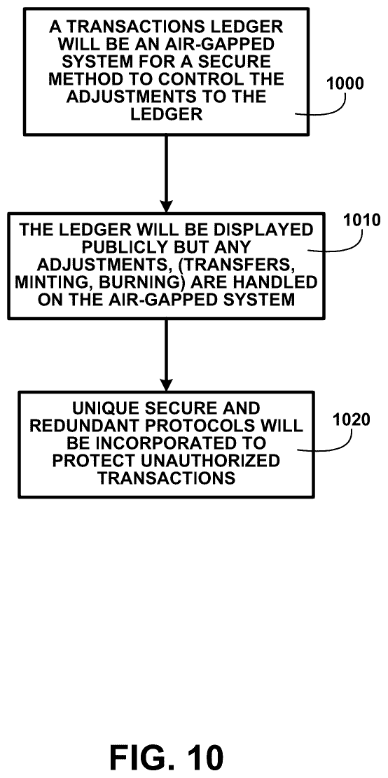

FIG. 10 shows a block diagram of an overview of the transactions ledger of one embodiment. FIG. 10 shows a transactions ledger will be an air-gapped system for a secure means to control the adjustments to the ledger 1000. The ledger will be displayed publicly but any adjustments, (transfers, minting, burning) are handled on the air-gapped system 1010. Unique secure and redundant protocols will be incorporated to protect unauthorized transactions 1020. The air-gapped system involves the main server which is not connected to the internet. It only gets information transmitted via a camera viewing a screen that is connected to a computer that is connected to the internet. This process prevents hackers from gaining access to the main system and making alterations to the ledger. The main system can only read data displayed on a terminal, which prevents hackers from being able to insert malicious code into the data entry process of one embodiment.

### Global Reward Dollars:

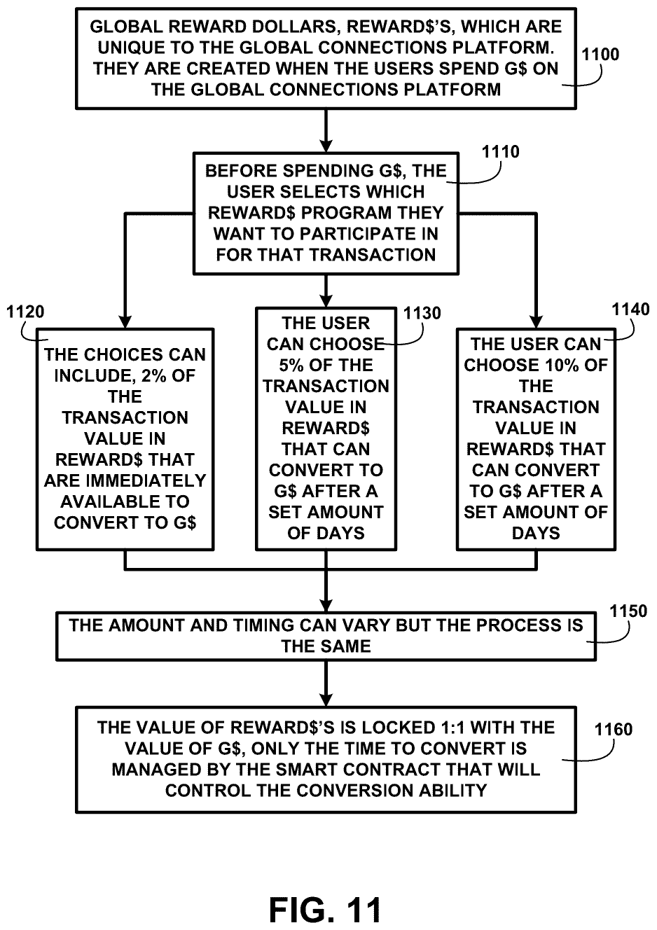

FIG. 11 shows a block diagram of an overview of global reward dollars of one embodiment. FIG. 11 shows global reward dollars (Reward$), which are unique to the global connections platform, they are created when the users spend G$ on the global connections platform 1100. Before spending G$, the user selects which reward$ program they want to participate in for that transaction 1110. The choices can include, 2% of the transaction value in reward$ that are immediately available to convert to G$ 1120. The user can choose 5% of the transaction value in reward$ that can convert to G$ after a set amount of days 1130. The user can choose 10% of the transaction value in reward$ that can convert to G$ after a set amount of days 1140. The amount and timing can vary but the process is the same 1150. The value of Reward$ is locked 1:1 with the value of G$, only the time to convert is managed by the smart contract that will control the conversion ability 1160 of one embodiment.

### Smart Contract:

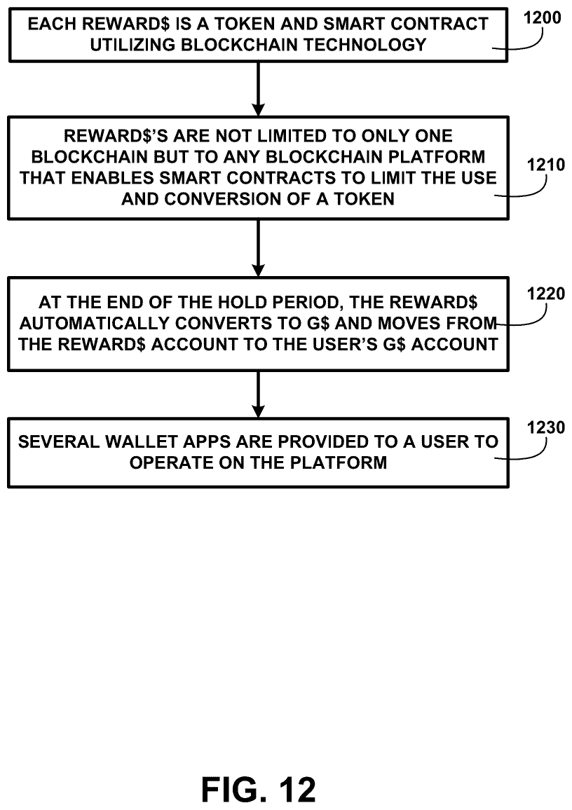

FIG. 12 shows a block diagram of an overview of a smart contract of one embodiment. FIG. 12 shows each reward$ is a token and smart contract utilizing blockchain technology 1200. Reward$ are not limited to only one blockchain but to any blockchain platform that enables smart contracts to limit the use and conversion of a token 1210. At the end of the hold period, the reward$ automatically converts to G$ and moves from the reward$ account to the user's G$ account 1220. Several wallet apps are provided to a user to operate on the platform 1230 of one embodiment.

### Global Reserve Real Estate Transfer Dollars:

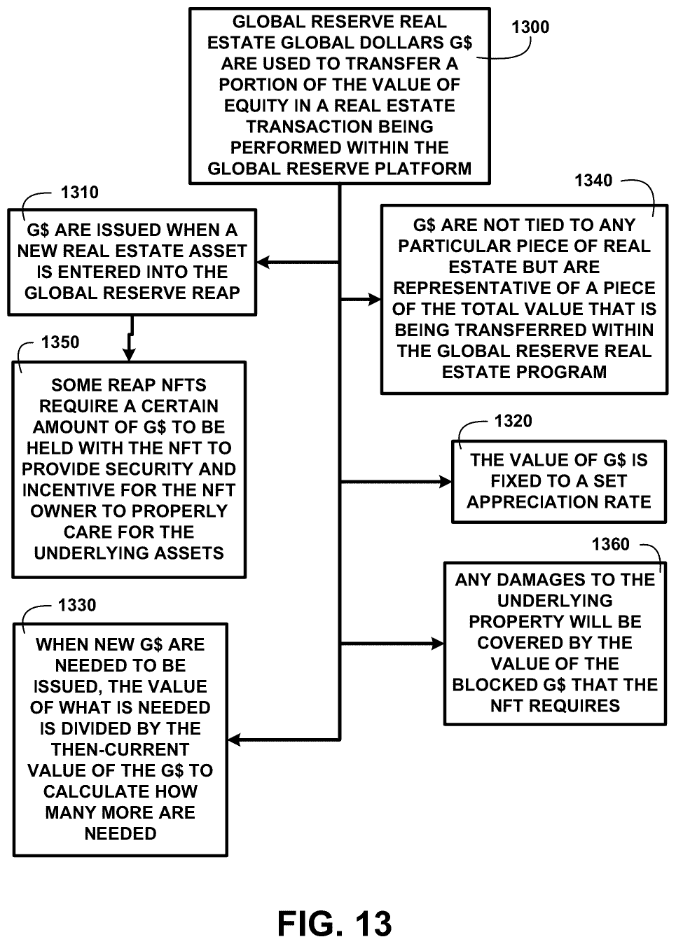

FIG. 13 shows a block diagram of an overview of global reserve real estate transfer dollars of one embodiment. FIG. 13 shows global reserve real estate transfer dollars G$ are used to transfer a portion of the value of equity in a real estate transaction being performed within the global reserve platform 1300. G$ are issued when a new real estate asset is entered into the global reserve reap 1310. The value of G$ is fixed to a set appreciation rate 1320. When new G$ are needed to be issued, the value of what is needed is divided by the then-current value of the G$ to calculate how many more are needed 1330. G$ are not tied to any particular piece of real estate but are representative of a piece of the total value that is being transferred within the global reserve real estate program 1340. Some reap NFTs require a certain amount of G$ to be held with the NFT to provide security and incentive for the NFT owner to properly care for the underlying assets 1350. Any damages to the underlying property will be covered by the value of the blocked G$ that the NFT requires 1360 of one embodiment.

### Global Connections Digital Asset:

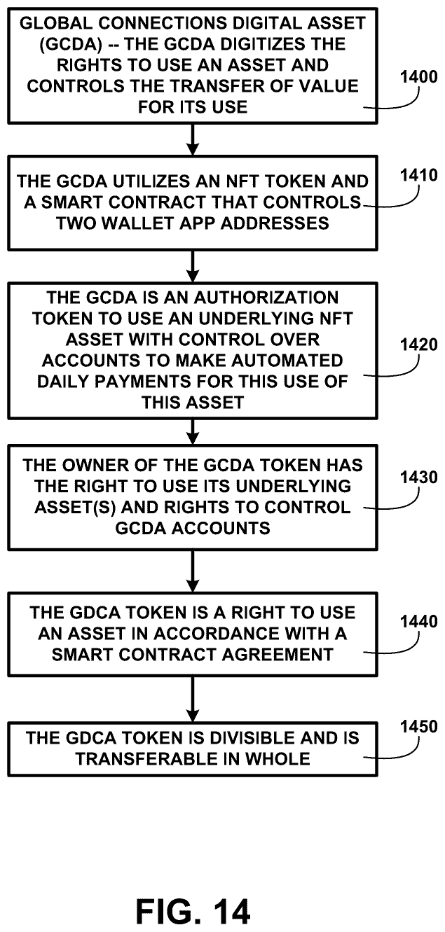

FIG. 14 shows a block diagram of an overview of global connections digital assets of one embodiment. FIG. 14 shows global connections digital asset (GCDA)—the GCDA digitizes the rights to use an asset and controls the transfer of value for its use 1400. The GCDA utilizes an NFT token and a smart contract that controls two wallet app addresses 1410. The GCDA is an authorization token to use an underlying NFT asset with control over accounts to make automated daily payments for this use of this asset 1420. The owner of the GCDA token has the right to use its underlying asset(s) and rights to control GCDA accounts 1430. The GDCA token is a right to use an asset in accordance with a smart contract agreement 1440. The GDCA token is divisible and is transferable in whole 1450 of one embodiment.

### GCDA is a Token:

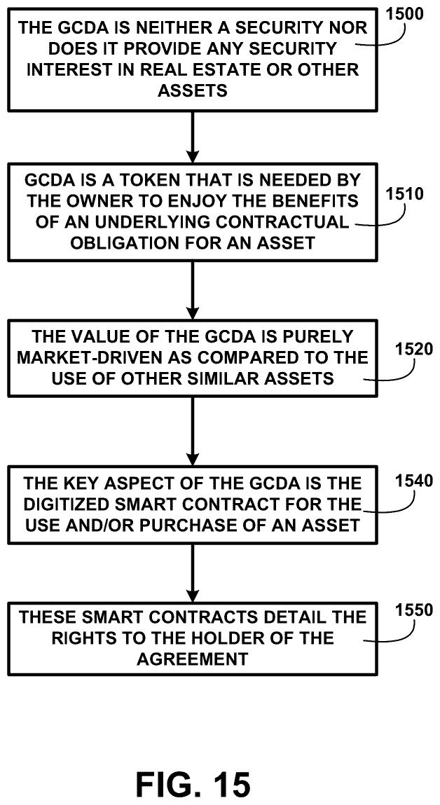

FIG. 15 shows a block diagram of an overview of GCDA as a token of one embodiment. FIG. 15 shows the GCDA is neither a security nor does it provide any security interest in real estate or other assets 1500. GCDA is a token that is needed by the owner to enjoy the benefits of an underlying contractual obligation for an asset 1510. The value of the GCDA is purely market-driven as compared to the use of other similar assets 1520. The key aspect of the GCDA is the digitized smart contract for the use and/or purchase of an asset 1540. These smart contracts detail the rights to the holder of the agreement 1550 of one embodiment.

### GCDA Smart Contracts:

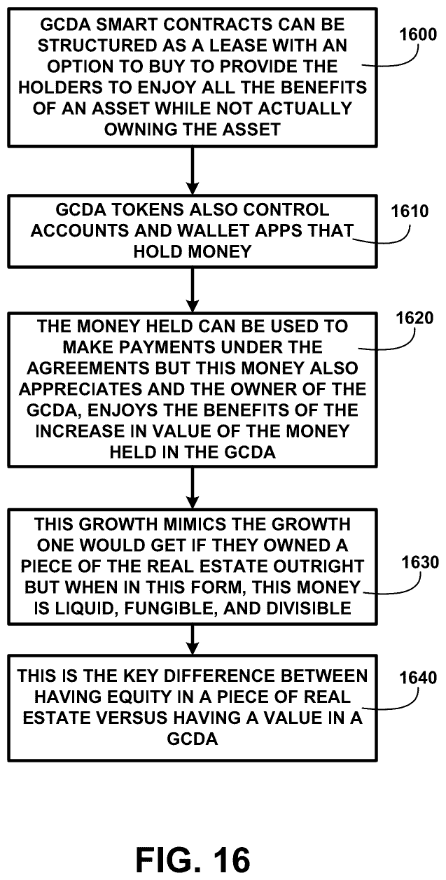

FIG. 16 shows a block diagram of an overview of GCDA smart contracts of one embodiment. FIG. 16 shows GCDA smart contracts can be structured as a lease with an option to buy to provide the holders to enjoy all the benefits of an asset while not actually owning the asset 1600. GCDA tokens also control accounts and wallet apps that hold money 1610. The money held can be used to make payments under the agreements but this money also appreciates and the owner of the GCDA enjoys the benefits of the increase in value of the money held in the GCDA 1620. This growth mimics the growth one would get if they owned a piece of the real estate outright but when in this form, this money is liquid, fungible, and divisible 1630. This is the key difference between having equity in a piece of real estate versus having a value in a GCDA 1640 of one embodiment.

### NFT Creation Process:

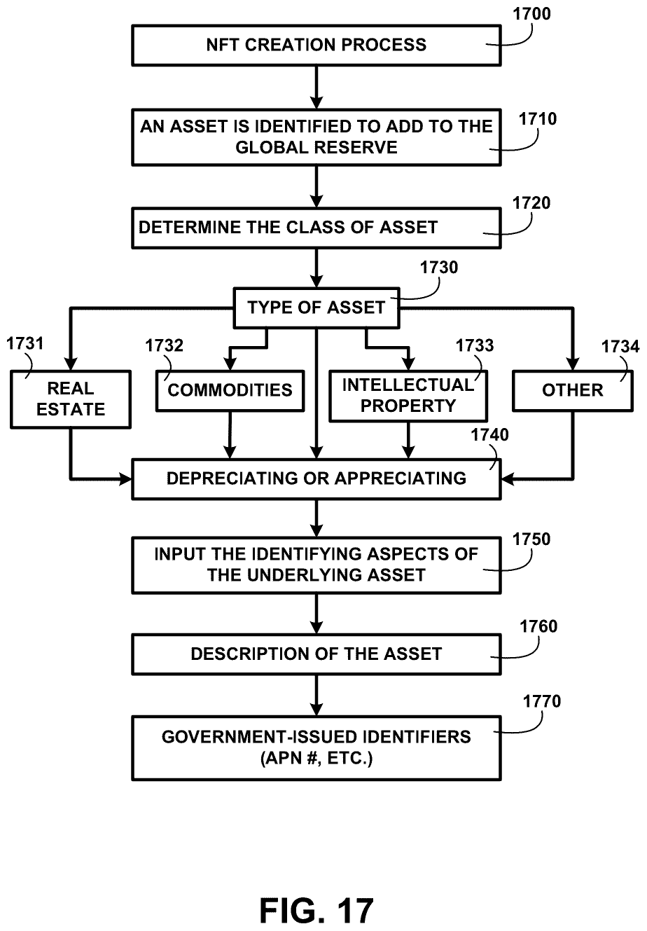

FIG. 17 shows a block diagram of an overview of the NFT creation process of one embodiment. FIG. 17 shows an NFT creation process 1700. An asset is identified to add to the global reserve 1710. The process begins to determine the class of asset 1720. The class of the asset is the type of asset 1730. The type of asset includes real estate 1731, commodities 1732, intellectual property 1733, and other 1734 types of assets. The process continues to determine whether the asset is depreciating or appreciating 1740. The process continues to input the identifying aspects of the underlying asset 1750, a description of the asset 1760, and any government-issued identifiers (apn #, etc.) 1770 where the assessor's parcel number (apn #) identifies the specific real estate parcel of one embodiment.

The NFT is created by the trust company that is holding the title of the real estate in the process of being transferred. The NFT contains the details and description of the real estate along with the terms and pricing to complete the process. The NFT is non-fungible and divisible. The NFT will also have fees due throughout the time that the NFT is active and the property has yet to be fully transferred. (A lease fee) The NFT contains full use rights to the underlying property and enables the owner of the NFT to sublease or improve the property and keep the net gains for themselves.

### Global Dollars:

Global Dollars are created upon the issuance of each new NFT in an amount equal to the number needed to represent the value of the real estate entering the trust and in the process of being transferred. The value is set in time and for each class of asset being transferred, the fixed appreciation rate is included. Anyone can acquire and hold Global Dollars. They are not limited to only parties in the process of buying or selling real estate. Buyers that acquired Global Dollars are not required to continue to hold them and can resell them and rebuy them several times throughout the time before completing the purchase and transfer.

### Trust Company:

A trust company is needed to hold the title of the properties in transition. This entity is responsible for the issuance of the NFT, the issuance of the Global Dollars, and the proper recording of title upon completion of the terms of the NFT.

### Underwriter:

This is the party that provides oversight of the parameters of the NFT. If fees are not paid in accordance or if there are other violations of the terms of the NFT, the Underwriter can foreclose on the NFT and take ownership away from the party failing to honor its terms. The underwriter can resell the NFT to any other party willing to accept its terms. The underwriter is responsible for the payments being honored under the agreement.

Buyer: The buyer is the party that currently owns the NFT and has the right to complete the purchase of the underlying real estate. The NFT can be purchased by a buyer when first created but transferred at a later time. The NFT can be transferred an unlimited amount of times and the current owner always has the right to complete the transfer if they can provide the Global Dollars needed for the completion.

### Seller:

The Seller is the party that owns the real estate and transfers it to the trust company in relation to the agreed terms of the NFT. Upon issuance of the NFT, the seller receives the noted amount of new Global Dollars related to the value of the real estate being transferred. Upon receipt of the agreed-upon Global Dollars, the seller's role in the transaction is complete and the seller has no other rights in the NFT or underlying real estate.

### Process:

In one example of the process of a buyer utilizing the NFT-REAP, a buyer and seller agree to the transfer of ownership of a piece of real estate. The buyer pays a fixed amount for the creation and acquisition of the NFT. He also may acquire additional Global Dollars to build up equity and to add to the amount eventually needed to complete the purchase.

In this example, the NFT requires an initial fee of 2% to cover fees for the trust and underwriter, plus an 8% minimum purchase and holding of Global Dollars. These Global Dollars are blocked in an account and used to cure any default of the NFT owner. It also requires a lease fee of 5%. If obligations under the NFT are not honored by the owner of the NFT, then the underwriter can follow the process to regain ownership of the NFT.

The owner of the NFT can sell their interest without approval by either the Trust or the underwriter. The NFT contains all of the provisions necessary to cure any defaults in the agreement and the owner of the NFT has full discretion to sell to whoever is willing to purchase.

The seller of the property gets the value agreed upon in Global Dollars. The seller can retain these or sell them on the marketplace for fiat currency, (USD). Since Global Dollars have a set appreciation, they can be used as an investment vehicle for anyone to buy and hold. The Global Dollar is considered personal property by the IRS and the appreciation is treated as a capital gain if and when sold.

The owner of the NFT that wants to take full ownership of the property in the future can make regular purchases of Global Dollars over time. This building of equity allows the NFT owner to gain the appreciation of an appreciating asset but also provides liquidity. If the NFT owner wants to liquidate some of their holdings, they are free to do so at any time. They just need the required amount in the future if they want to complete the transfer.

The NFT owner can also sell the NFT to another party that may want to take interest in the underlying property and complete the transfer themself. The value of the NFT can vary based on the value of the number of Global Dollars needed to complete the transfer versus the current value of the underlying property. If the real estate has appreciated more than the appreciation rate of the Global Dollars, then the value of the NFT would be greater. If the owner of the NFT also made improvements to the underlying property, then the value of the NFT would also be greater.

The NFT REAP is a leasehold interest in the property with the option to purchase and all are recorded and carried out with blockchain technology.

### Legal Agreement for the Asset:

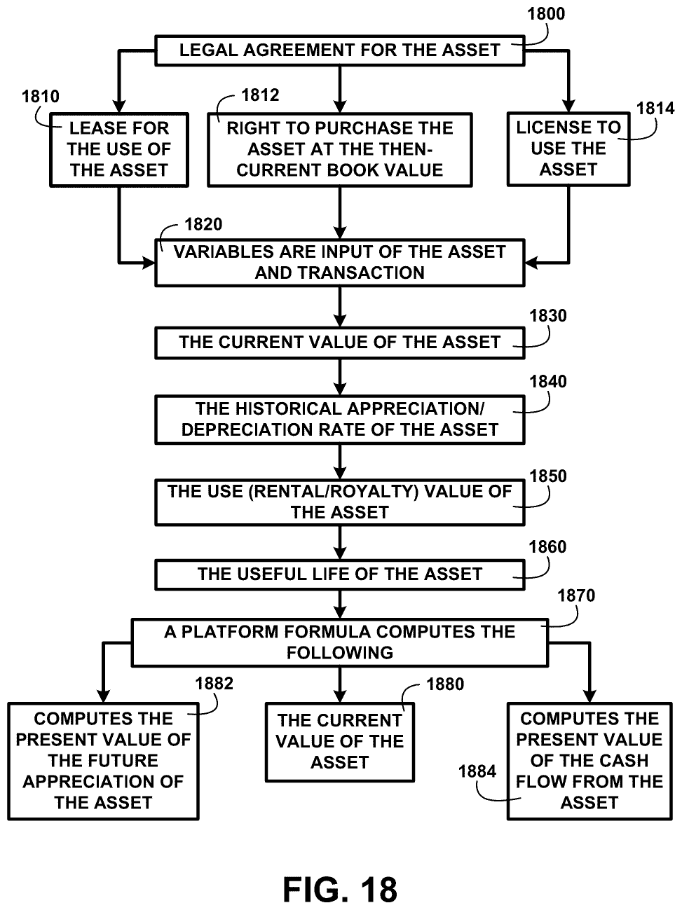

FIG. 18 shows a block diagram of an overview of the legal agreement for the asset of one embodiment. FIG. 18 shows the legal agreement for the asset 1800 with the owner of the asset. The legal agreement can be a lease for the use of the asset 1810. The legal agreement can be a right to purchase the asset at the then-current book value 1812. A license to use the asset 1814 could be the legal agreement for commodities 1732 of FIG. 17 and intellectual property 1733 of FIG. 17. Variables are the input of the asset and transaction 1820. The variables include at least the current value of the asset 1830, the historical appreciation/depreciation rate of the asset 1840, the use (rental/royalty) value of the asset 1850, and the useful life of the asset 1860.

A platform formula computes the following 1870 including the current value of the asset 1880, computes the present value of the future appreciation of the asset 1882, and computes the present value of the cash flow from the asset 1884 of one embodiment.

### The NFT Asset Value:

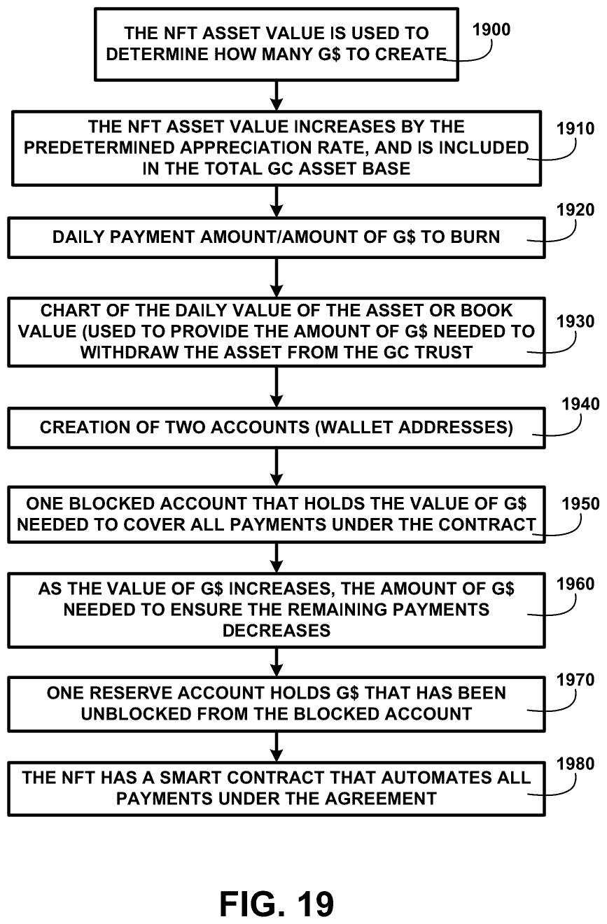

FIG. 19 shows a block diagram of an overview of the NFT asset value of one embodiment. FIG. 19 shows the NFT asset value is used to determine how many G$ to create 1900. The NFT asset value increases by the predetermined appreciation rate, and is included in the total global connections (GC) asset base 1910. A daily payment amount/amount of G$ to burn 1920 for the asset is determined. The platform automatically prepares a chart of the daily value of the asset or book value (used to provide the amount of G$ needed to withdraw the asset from the GC trust 1930. Creation of two accounts (wallet addresses) 1940 is made including one blocked account that holds the value of G$ needed to cover all payments under the contract 1950. As the value of G$ increases, the amount of G$ needed to ensure the remaining payments decreases 1960. The other account is one reserve account that holds G$ that has been unblocked from the blocked account 1970. The NFT has a smart contract that automates all payments under the agreement 1980 of one embodiment.

### Authorized Party(s) to Control the NFT:

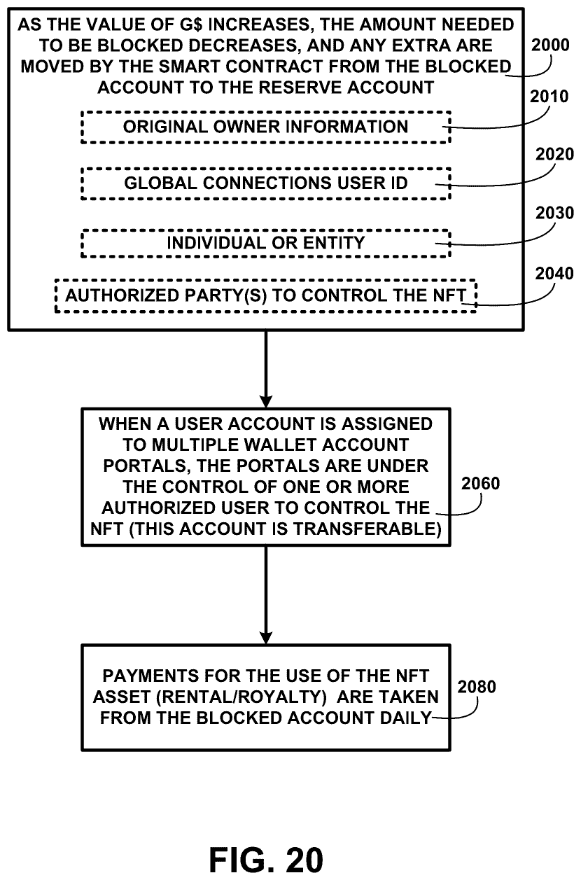

FIG. 20 shows a block diagram of an overview of an authorized party(s) to control the NFT of one embodiment. FIG. 20 shows as the value of G$ increases, the amount needed to be blocked decreases, and any extra are moved by the smart contract from the blocked account to the reserve account 2000. The original owner information 2010 in the global connections user ID 2020 for an individual or entity 2030 provides the authorized party(s) to control the NFT 2040. When a user account is assigned to multiple wallet account portals, the portals are under the control of one or more authorized users to control the NFT (this account is transferable) 2060. Payments for the use of the NFT asset (rental/royalty) are taken from the blocked account daily 2080 of one embodiment.

### Liens Against the NFT and its Accounts:

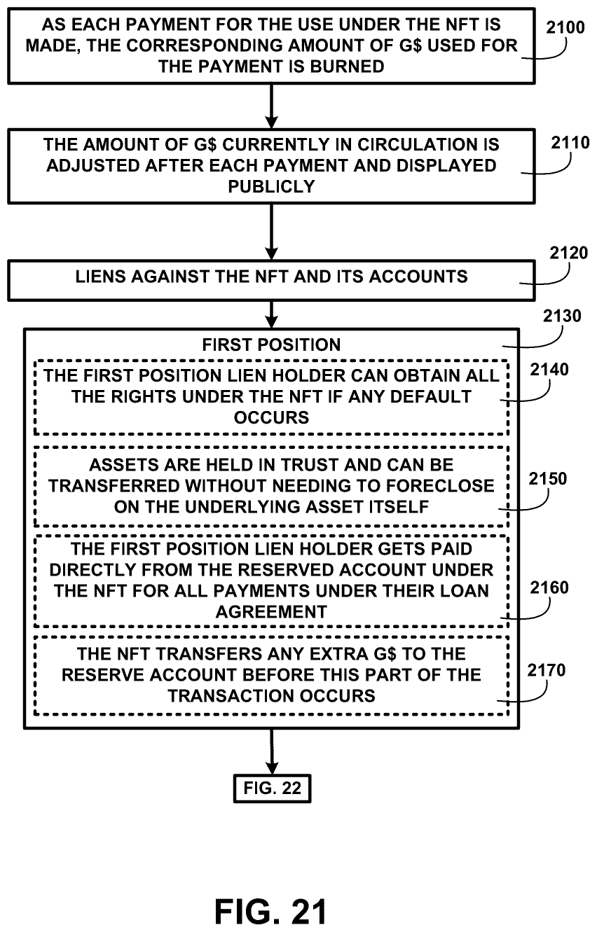

FIG. 21 shows a block diagram of an overview of liens against the NFT and its accounts of one embodiment. FIG. 21 shows as each payment for the use under the NFT is made, the corresponding amount of G$ used for the payment is burned 2100. The amount of G$ currently in circulation is adjusted after each payment and displayed publicly 2110. The NFT may include liens against the NFT and its accounts 2120. Liens are tracked based on lien position for example first, second, and third. A first position 2130 means the first position lien holder can obtain all the rights under the NFT if any default occurs 2140. Assets are held in trust and can be transferred without needing to foreclose on the underlying asset itself 2150. The first position lien holder gets paid directly from the reserved account under the NFT for all payments under their loan agreement 2160. The NFT transfers any extra G$ to the reserve account before this part of the transaction occurs 2170 of one embodiment.

### The NFT Transfers:

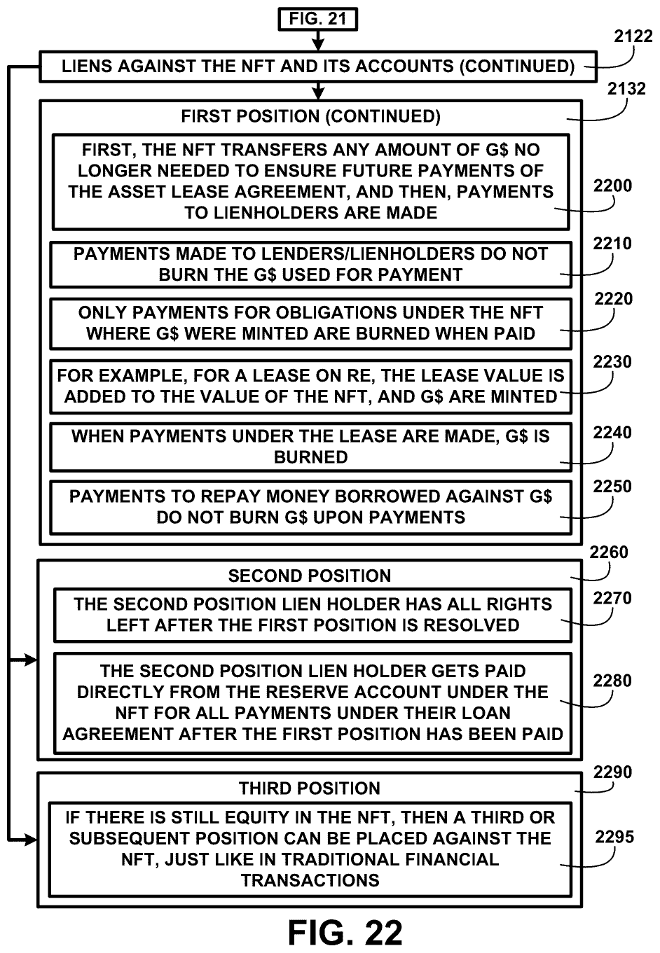

FIG. 22 shows a block diagram of an overview of the NFT transfers of one embodiment. FIG. 22 shows liens against the NFT and its accounts (continued) 2122 with the first position (continued) 2132. First, the NFT transfers any amount of G$ no longer needed to ensure future payments of the asset lease agreement, and then, payments to lienholders are made 2200. Payments made to lenders/lienholders do not burn the G$ used for payment 2210. Only payments for obligations under the NFT where G$ were minted are burned when paid 2220, for example, for a lease on real estate (RE), the lease value is added to the value of the NFT, and G$ are minted 2230. When payments under the lease are made, G$ is burned 2240. Payments to repay money borrowed against G$ do not burn G$ upon payments 2250.

A second position 2260 lien provides the second position lien holder has all rights left after the first position is resolved 2270. The second position lien holder gets paid directly from the reserve account under the NFT for all payments under their loan agreement after the first position has been paid 2280.

A third position 2290 lien, if there is still equity in the NFT, then a third or subsequent position can be placed against the NFT, just like in traditional financial transactions 2295 of one embodiment.

### GCDA NFT:

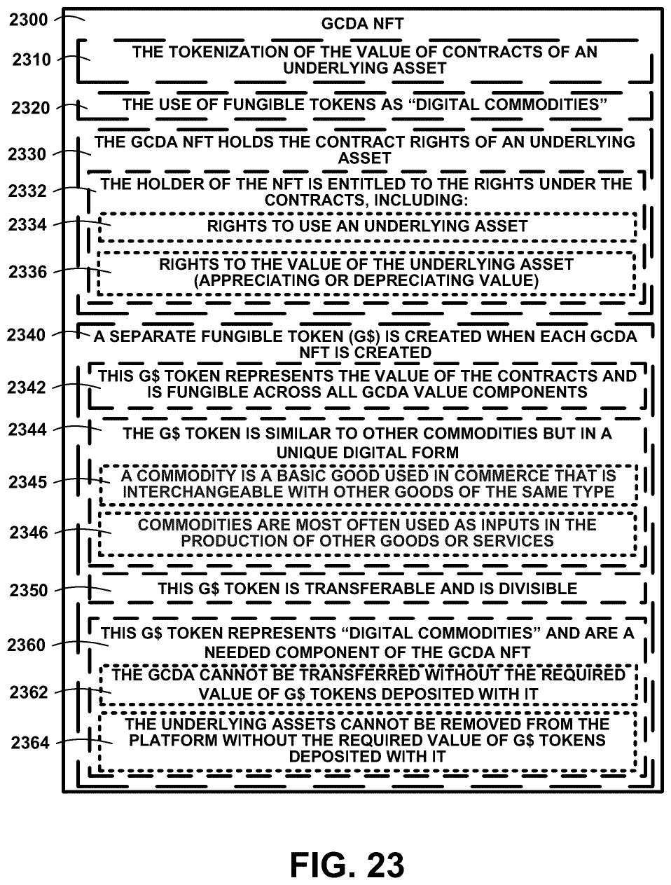

FIG. 23 shows a block diagram of an overview of the GCDA NFT of one embodiment. FIG. 23 shows the GCDA NFT 2300 that comprises the tokenization of the value of contracts of an underlying asset 2310. The use of fungible tokens as “digital commodities” 2320 is a part of the tokenization of the value of contracts of an underlying asset 2310.

The GCDA NFT holds the contract rights of an underlying asset 2330. The holder of the NFT is entitled to the rights under the contracts, including 2332 rights to use an underlying asset 2334, and rights to the value of the underlying asset (Appreciating or Depreciating value) 2336.

A separate Fungible Token (G$) is created when each GCDA NFT is created 2340. This G$ token represents the value of the contracts and is fungible across all GCDA value components 2342. The G$ token is similar to other commodities but in a unique digital form 2344. A commodity is a basic good used in commerce that is interchangeable with other goods of the same type 2345. Commodities are most often used as inputs in the production of other goods or services 2346. This G$ token is transferable and is divisible 2350.

This G$ token represents “Digital Commodities” and is a needed component of the GCDA NFT 2360. The GCDA cannot be transferred without the required value of G$ tokens deposited with it 2362. The underlying assets cannot be removed from the platform without the required value of G$ tokens deposited with it 2364 of one embodiment.

### Quantum State Encryption (QSE):

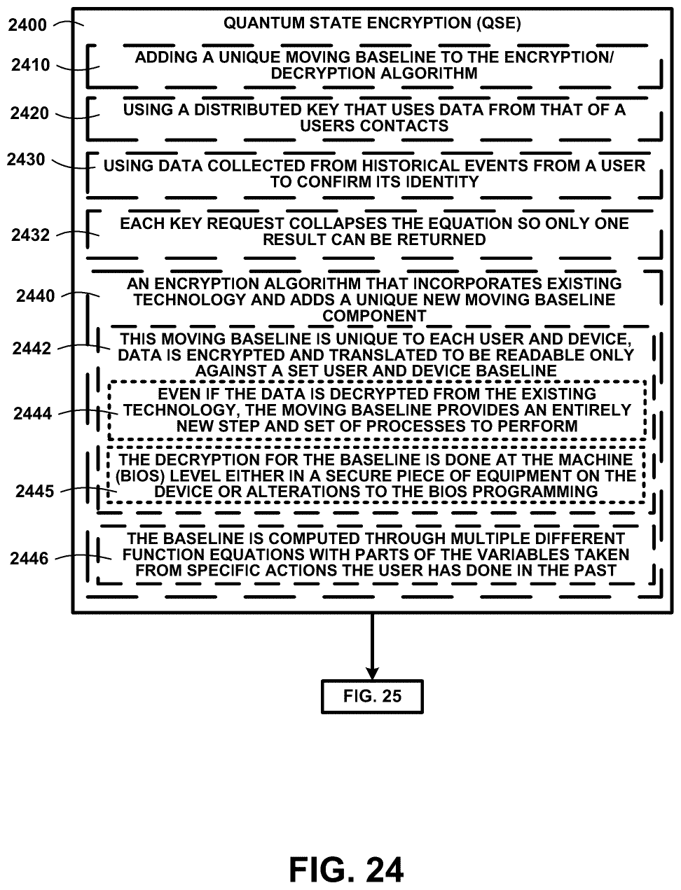

FIG. 24 shows a block diagram of an overview of the Quantum State Encryption (QSE) of one embodiment. FIG. 24 shows the Quantum State Encryption (QSE) 2400 functions and operations. Adding a unique moving baseline to the encryption/decryption algorithm 2410. Using a distributed key that uses data from that of a user's contacts 2420. Using data collected from historical events from a user to confirm its identity 2430. Each key request collapses the equation so only one result can be returned 2432. QSE is an encryption algorithm that incorporates existing technology and adds a unique new moving baseline component 2440. This moving baseline is unique to each user and device. Data is encrypted and translated to be readable only against a set user and device baseline 2442.

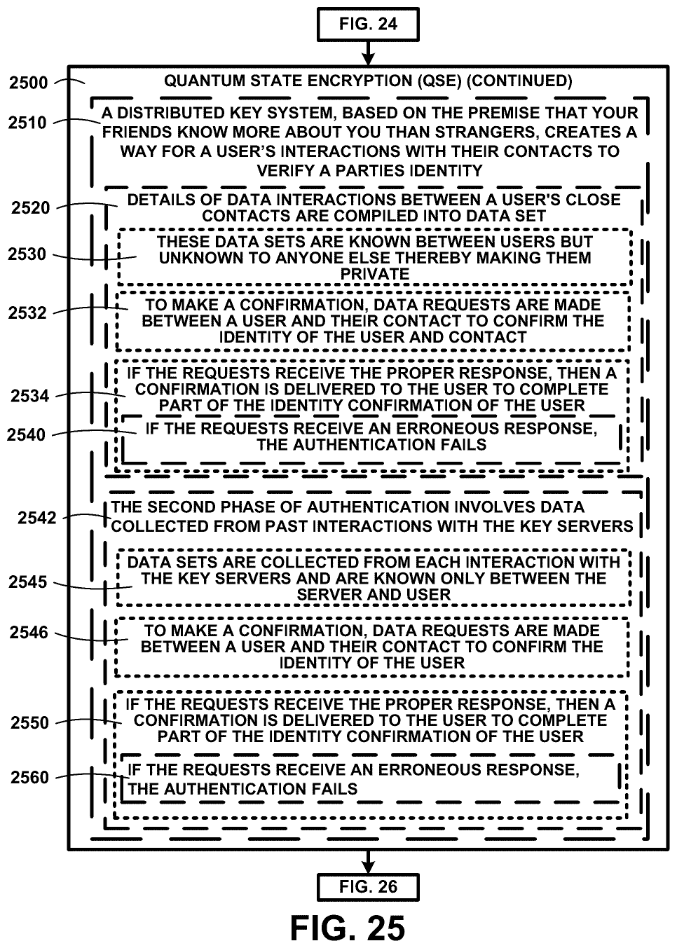

Even if the data is decrypted from the existing technology, the moving baseline provides an entirely new step and set of processes to perform 2444. The decryption for the baseline is done at the machine (bios) level either in a secure piece of equipment on the device or alterations to the bios programming 2445. The baseline is computed through multiple different function equations with parts of the variables taken from specific actions the user has done in the past 2446. The descriptions continue in FIG. 25 of one embodiment.

### Quantum State Encryption (QSE) (Continued):

FIG. 25 shows a block diagram of an overview of the Quantum State Encryption (QSE) (continued) of one embodiment. FIG. 25 shows a continuation from FIG. 24 for the Quantum State Encryption (QSE) 2500. A distributed key system, based on the premise that your friends know more about you than strangers, creates a way for a user's interactions with their contacts to verify a party's identity 2510. Details of data interactions between a user's close contacts are compiled into data set 2520. These data sets are known between users but unknown to anyone else thereby making them private 2530. To make a confirmation, data requests are made between a user and their contact to confirm the identity of the user and contact 2532. If the requests receive the proper response, then a confirmation is delivered to the user to complete part of the identity confirmation of the user 2534. If the requests receive an erroneous response, the authentication fails 2540.

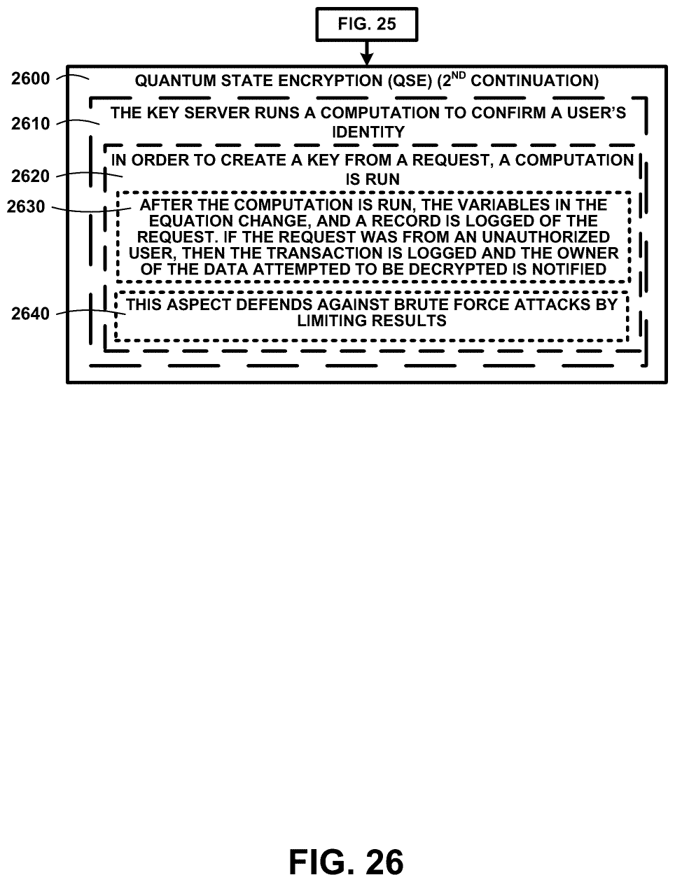

The second phase of authentication involves data collected from past interactions with the key servers 2542. Data sets are collected from each interaction with the key servers and are known only between the server and user 2545. To make a confirmation, data requests are made between a user and their contact to confirm the identity of the user 2546. If the requests receive the proper response, then a confirmation is delivered to the user to complete part of the identity confirmation of the user 2550. If the requests receive an erroneous response, the authentication fails 2560. Descriptions continue in FIG. 26 of one embodiment.

### Quantum State Encryption (QSE) (2^{ND} Continuation):

FIG. 26 shows a block diagram of an overview of the Quantum State Encryption (QSE) (2^{ND} continuation) of one embodiment. FIG. 26 shows a 2^{ND} continuation from FIG. 25 of the Quantum State Encryption (QSE) 2600. The QSE provides security for the global reserve platform 500 of FIG. 5. In one operation the key server runs a computation to confirm a user's identity 2610. In order to create a key from a request, a computation is run 2620. After the computation is run, the variables in the equation change and a record is logged of the request. If the request was from an unauthorized user, then the transaction is logged and the owner of the data attempted to be decrypted is notified 2630. This aspect defends against brute force attacks by limiting results 2640 of one embodiment.

The foregoing has described the principles, embodiments, and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An image capturing system, comprising:
at least one transactions ledger public screen coupled to a transaction marketplace platform configured to display the current status of user transactions;
an air-gapped system platform configured to securely control adjustments to the transactions ledger;
a camera coupled to the air-gapped system platform configured to capture images of the at least one transactions ledger public screen display of the current status of user transactions;
an optical character recognition device coupled to the camera configured to convert the captured image into text;
a computer coupled to the air-gapped system platform configured to adjust the transaction status;
a quantum state encryption device coupled to the computer configured to encrypt the adjustments to the transaction status; and
a portable memory device coupled to the air-gapped system platform computer configured to record the encrypted adjustments to the transaction status and further configured to non-wirelessly transfer the encrypted adjustments to the transaction status to a database of the transaction marketplace platform.

2. The image capturing system of claim 1, further comprising a transaction marketplace platform including at least a plurality of digital servers, a plurality of databases, at least one platform computer, and a quantum state encryption device.

3. The image capturing system of claim 1, wherein the camera capture of displayed transactions status images are configured to prevent internet hacking of transaction adjustments.

4. The image capturing system of claim 1, further comprising a quantum state encryption device coupled to the computer configured to encrypt the completed transactions status adjustments, wherein the quantum state encryption device incorporates a distributed key that uses data from historical events from a user and a user specific device.

5. The image capturing system of claim 1, wherein the secure camera captured transaction adjustments include real estate, commodities, intellectual property, and other smart contract transactions.

6. The image capturing system of claim 1, wherein the digital transaction ledger is housed in an air gapped security system platform in a secure area only accessible by authorized personnel.

7. The image capturing system of claim 1, further comprising a search feature of the transaction marketplace platform, wherein a user enters the transaction marketplace platform and searches for an asset the user wants to acquire.

8. The image capturing system of claim 1, further comprising at least one user mobile device wirelessly coupled to the transaction marketplace platform configured to receive and record at least one user transaction registration.

9. The image capturing system of claim 1, further comprising an acquisition section feature of the transaction marketplace platform wirelessly coupled to a user mobile device configured to collect the user's information to confirm the user has adequate funds to complete the transaction to acquire an asset (property) that the user wants to acquire.

10. The image capturing system of claim 1, further comprising a plurality of databases coupled to a transaction marketplace platform configured to form a distributed database.

11. An apparatus, comprising:
at least one user mobile device configured to register transactions;
a transaction marketplace app coupled to the at least one user mobile device configured to transmit the transactions for registration;
at least one transactions ledger public screen coupled to a transaction marketplace platform configured to display the current status of user transactions;
an air-gapped system platform configured to securely control adjustments to the transactions ledger;
a camera coupled to the air-gapped system platform configured to capture images of the at least one transactions ledger public screen display of the current status of user transactions;
an optical character recognition device coupled to the camera configured to convert the captured image into text;
a computer coupled to the air-gapped system platform configured to adjust the transaction status;
a quantum state encryption device coupled to the computer configured to encrypt the adjustments to the transaction status; and
a portable memory device coupled to the air-gapped system platform computer configured to record the encrypted adjustments to the transaction status and further configured to non-wirelessly transfer the encrypted adjustments to the transaction status to a database of the transaction marketplace platform.

12. The apparatus of claim 11, further comprising a transaction marketplace platform including at least a plurality of digital servers, a plurality of databases, at least one platform computer, and a quantum state encryption device.

13. The apparatus of claim 11, further comprising a quantum state encryption device coupled to the computer configured to encrypt the completed transaction status adjustments.

14. The apparatus of claim 11, wherein the digital transaction ledger is housed in an air gapped security system platform in a secure area only accessible by authorized personnel.

15. The apparatus of claim 11, wherein the secure camera captured transactions adjustments include real estate, commodities, intellectual property, and other smart contract transactions.

16. An apparatus, comprising:
at least one transactions ledger public screen coupled to a transaction marketplace platform configured to display the current status of user transactions;
an air-gapped system platform configured to securely control adjustments to the transactions ledger;
a camera coupled to the air-gapped system platform configured to capture images of the at least one transactions ledger public screen display of the current status of user transactions;
an optical character recognition device coupled to the camera configured to convert the captured image into text;
a computer coupled to the air-gapped system platform configured to adjust the transaction status;
a quantum state encryption device coupled to the computer configured to encrypt the adjustments to the transaction status; and
a portable memory device coupled to the air-gapped system platform computer configured to record the encrypted adjustments to the transaction status and further configured to non-wirelessly transfer the encrypted adjustments to the transaction status to a database of the transaction marketplace platform.

17. The apparatus of claim 16, further comprising a customizable asset control feature coupled to the transaction marketplace platform configured to set user selected transaction details and use of the asset including at least set an asset monthly lease fee, a sublet smart contract, an exchange of assets, or transfer a smart contract to another asset.

18. The apparatus of claim 16, wherein the camera capture of displayed transactions status images are configured to prevent internet hacking of transactions adjustments.

19. The apparatus of claim 16, further comprising a quantum state encryption device coupled to the computer configured to encrypt the completed transaction status adjustments, wherein the quantum state encryption device incorporates a distributed key that uses data from historical events from a user and a user specific device.

20. The apparatus of claim 16, further comprising a transaction marketplace platform wirelessly coupled to at least one user mobile device configured to receive and record at least one user transaction registration.
